(19) United States
(12) Patent Application Publication
(10) Pub. No.: US 2010/0000554 A1
(43) Pub. Date: Jan. 7, 2010

(54) Device for Detecting a Characteristic of a Fibrous Material

(75) Inventor: Marco Dionigi, Perugia (IT)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: G.D.SOCIETA'PER AZIONI, Bologna (IT)

(21) Appl. No.: 12/376,042

(22) PCT Filed: Aug. 2, 2007
(86) PCT No.: PCT/IB2007/002221

§ 371 Date: Jun. 22, 2009

(30) Foreign Application Priority Data
Aug. 3, 2006 (IT) BO2006A000585

(51) Int. Cl. A24C 5/34; G01N 22/00

(52) U.S. Cl. 131/280; 73/159

(57) ABSTRACT

A device (4) for detecting the density and/or humidity of tobacco and/or the presence of foreign substances; the device (4) having a microwave resonator (5), which includes a substantially cylindrical metal body (10) with an axial through hole (13), and an L-shaped chamber (11) inside the body (10).

### TECHNICAL FIELD

The present invention relates to a device for detecting at least one characteristic of a fibrous material; to a resonator of the device; and to a machine for producing cylindrical articles of the tobacco industry, in particular cigarettes, and comprising such a device.

More specifically, the present invention relates to a device for detecting at least one characteristic of a fibrous material, and comprising a passage, along which the fibrous material is fed, in use, in a given direction; and a microwave resonator. The resonator comprises at least one body of conducting material; at least one chamber bounded by the body; emitting means for emitting microwave signals; and receiving means for receiving microwave signals. And the chamber contains at least a first dielectric material.

Herein, “fibrous material” is intended to mean a material containing fibres, and is preferably selected from the group comprising: tobacco and cellulose acetate.

Herein, “characteristic of a fibrous material” is intended to mean a characteristic selected from the group comprising: density, humidity, and foreign substances.

### BACKGROUND ART

U.S. Pat. No. 6,452,404 describes a device for measuring the humidity of tobacco, and comprising a substantially cylindrical microwave resonator having a through axial hole.

Detecting devices of the above type have the drawback of being fairly bulky, especially when the resonator is intended for use at relatively low frequencies. In which case, known resonators are fairly bulky, substantially perpendicular to the given direction.

When measuring the humidity and/or density of the tobacco of two cigarette rods travelling parallel and a relatively small distance apart, known relatively bulky resonators are extremely difficult to position.

### DISCLOSURE OF INVENTION

It is an object of the present invention to provide a device for detecting at least one characteristic of a fibrous material, a resonator of the device, and a machine for producing cylindrical articles of the tobacco industry and comprising such a device; all of which provide for at least partly eliminating the aforementioned drawbacks, while at the same time being cheap and easy to implement.

According to the present invention, there are provided a device for detecting at least one characteristic of a fibrous material, a resonator of the device, and a machine for producing cylindrical articles of the tobacco industry and comprising such a device, as claimed in the accompanying independent Claims or in any one of the Claims depending directly or indirectly on the independent Claims.

### BRIEF DESCRIPTION OF THE DRAWINGS

A number of non-limiting embodiments of the present invention will be described by way of example with reference to the accompanying drawings, in which:

FIG. 1 shows a schematic front view, with parts removed for clarity, of a portion of a cigarette manufacturing machine in accordance with the present invention;

FIG. 2 shows a schematic view in perspective, with parts removed for clarity, of a humidity and/or density detecting device in accordance with the present invention;

FIG. 3 shows a longitudinal section of the FIG. 2 device;

FIG. 4 shows a longitudinal section of a further embodiment of the FIG. 3 device;

FIG. 5 shows a test data graph, in which the x axis shows frequency in GHz, and the y axis shows the power measurement;

FIG. 6 shows a test data graph, in which the x axis shows frequency deviations in GHz, and the y axis shows power measurement deviations;

FIG. 7 shows lines plotted by linear interpolation of test data obtained measuring tobacco of known density and humidity; the x axis shows the A_{Δ}/Aᵢ ratio, and the y axis shows density;

FIG. 8 shows a schematic of the test-detected intensity of an electric component of a microwave field generated by the FIG. 1 device;

FIG. 9 shows a schematic of the test-detected intensity of a further electric component of a microwave field generated by the FIG. 1 device.

### BEST MODE FOR CARRYING OUT THE INVENTION

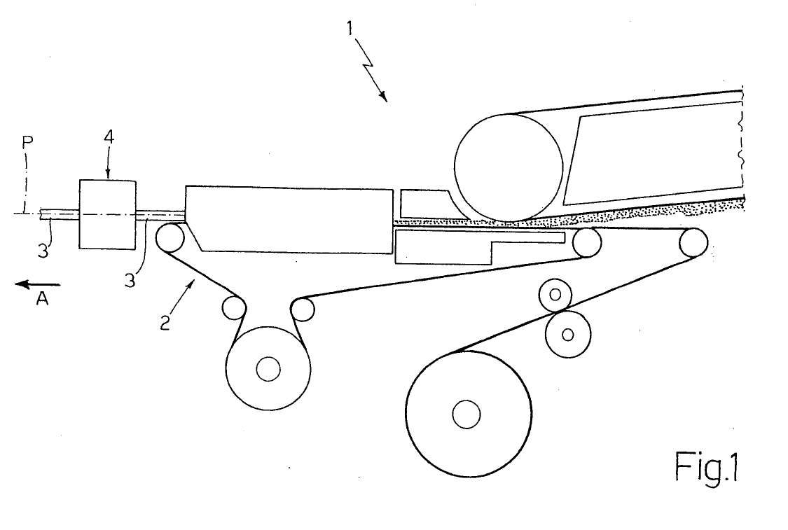

FIG. 1 shows a portion of a machine 1 for producing cigarettes. Machine 1 comprises a conveyor 2 for feeding a cigarette rod 3 (i.e. a paper-wrapped rope of tobacco) along a path P in a given direction A and through a detecting device 4 (shown schematically in FIG. 1) for detecting the density and/or humidity of the tobacco in cigarette rod 3.

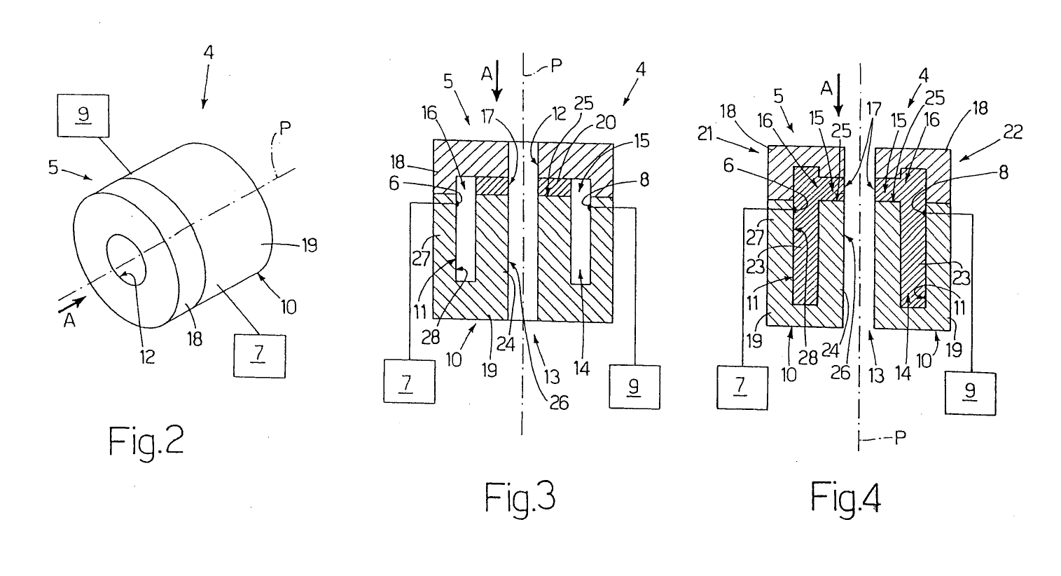

With particular reference to FIGS. 2 and 3, device 4 comprises a microwave resonator 5 for measuring the density and/or humidity of the tobacco, and which produces a microwave field of given geometry, and emits detection signals. More specifically, resonator 5 comprises an emitting antenna 6 connected to a generator 7; and a receiving antenna 8 connected to a processor 9.

Emitting antenna 6 and receiving antenna 8 are positioned crosswise, preferably perpendicularly, to direction A to achieve optimum emission and reception of the microwave field.

Resonator 5 comprises a body 10 of at least one conducting material, in particular a metal such as steel; and a chamber 11 bounded by body 10. Chamber 11 contains at least one dielectric material, by which is meant a material of poor conduction, but capable of relatively effectively sustaining electric fields. Non-limiting examples of dielectric materials comprise: air; polymer materials in liquid, solid, foam, or gel form (e.g. polyethylene or polyurethane, which may assume a solid or gel or foam form); organic liquids (i.e. liquids containing carbon compounds); and a vacuum.

As shown in FIGS. 2 and 3, body 10 is of substantially circular cylindrical annular shape, and defines a lumen 12 substantially coaxial with body 10 and at least partly defining a passage 13, along which cigarette rod 3 is fed, in use.

Chamber 11 has an L-shaped section parallel to direction A, and comprises a portion 14 substantially parallel to direction A; and a portion 15 crosswise, in particular substantially perpendicular, to direction A. Portion 15 has one end 16 connected to portion 14; and an open end 17, i.e. not bounded by the conducting material, opposite end 16 and facing passage 13. More specifically, end 17 is bounded by passage 13. In preferred embodiments, end 17, measured parallel to direction A, is 0.5 to 3 millimetres long, and more preferably one millimetre long.

Portions 14 and 15 are of respective annular shapes substantially coaxial with each other and with body 10. More specifically, portions 14 and 15 are of respective substantially circular cylindrical shapes.

Body 10 comprises two half-shells 18 and 19, which, when combined, define chamber 11. Half-shells 18 and 19 are annular and joined by fastening means, in particular two screws (not shown).

Resonator 5 is substantially a coaxial resonator, in which portion 14 acts as a short-circuited transmission line, and half-shells 18 and 19 define a capacitance at portion 15.

Body 10 comprises a wall 24 separating portion 14 and passage 13, and having an end surface 25, and an outer surface 26 crosswise to end surface 25 and at least partly defining passage 13; and a wall 27 located on the opposite side of portion 14 to wall 24, and having an inner surface 28. End surface 25 partly defines portion 15, and is of a width, measured substantially perpendicularly to direction A, greater than or equal to (preferably greater than) half the distance, measured parallel to said width at portion 15, between inner surface 28 and outer surface 26. More specifically, outer surface 26 is substantially parallel to inner surface 28 and substantially perpendicular to end surface 25; and the width and distance are measured radially with respect to a longitudinal axis of body 10 extending along lumen 12.

Resonator 5 also comprises a separator 20, which is made of dielectric material, is of substantially circular cylindrical annular shape, and is substantially coaxial with body 10 and portions 14 and 15. More specifically, separator 20 is housed inside portion 15, at end 17, and is shaped to substantially prevent tobacco particles from entering chamber 11. The dielectric constant of the dielectric material of separator 20 preferably differs from that of the dielectric material inside portion 14 of chamber 11. In a preferred embodiment, chamber 11 contains air; and the separator is of polyethylene.

In alternative embodiments not shown, chamber 11 has a T-shaped section parallel to direction A.

In alternative embodiments, chamber 11 contains low-pressure air, i.e. at below atmospheric pressure, or a vacuum.

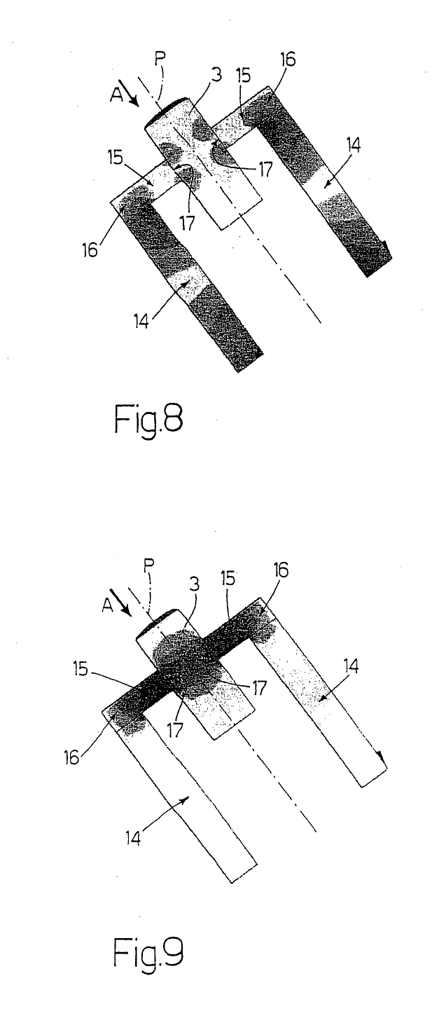

FIG. 8 shows, schematically, the intensity of the electric component, perpendicular to direction A, of the microwave field generated by resonator 5; FIG. 9 shows, schematically, the intensity of the electric component, parallel to direction A, of the microwave field generated by resonator 5; and the darker areas indicate greater intensity. As shown in FIGS. 8 and 9, the microwave field is particularly strong in portion 15 of chamber 11 and in the portion of passage 13 at portion 15. Concentration of the field at portion 15 is mainly due to the particular geometry of chamber 11, as opposed to the type of dielectric material in chamber 11.

Certain geometrical elements of resonator 5, and in particular of chamber 11, allow a variation in microwave field frequency without altering the radial size of body 10. In this connection, it is important to note that increasing the length of portion 14 provides for reducing microwave field frequency, so that relatively small resonators 5 can be obtained, and which can also be used to advantage on cigarette manufacturing machines on which two or more parallel cigarette rods 3 are advanced side by side.

Particularly advantageous, as regards microwave field frequency variation, is the dimensional relationship, referred to above, between the width of end surface 25 and the distance between inner surface 28 and outer surface 26.

In actual use, as cigarette rod 3 travels through device 4, resonator 5 generates the microwave field, which is disturbed by the tobacco in cigarette rod 3, and emits a disturbance-dependent detection signal. At this point, processor 9 compares the detection signal with a reference data item. More specifically, processor 9 determines a detection data item as a function of the detection signal, and compares the detection data item with the reference data item. When the difference between the detection signal and the reference data item exceeds a given threshold value, an error signal is emitted indicating a flawed portion of cigarette rod 3; in which case, a reject unit (not shown), downstream from device 4 and connected to processor 9, eliminates the flawed portion of cigarette rod 3.

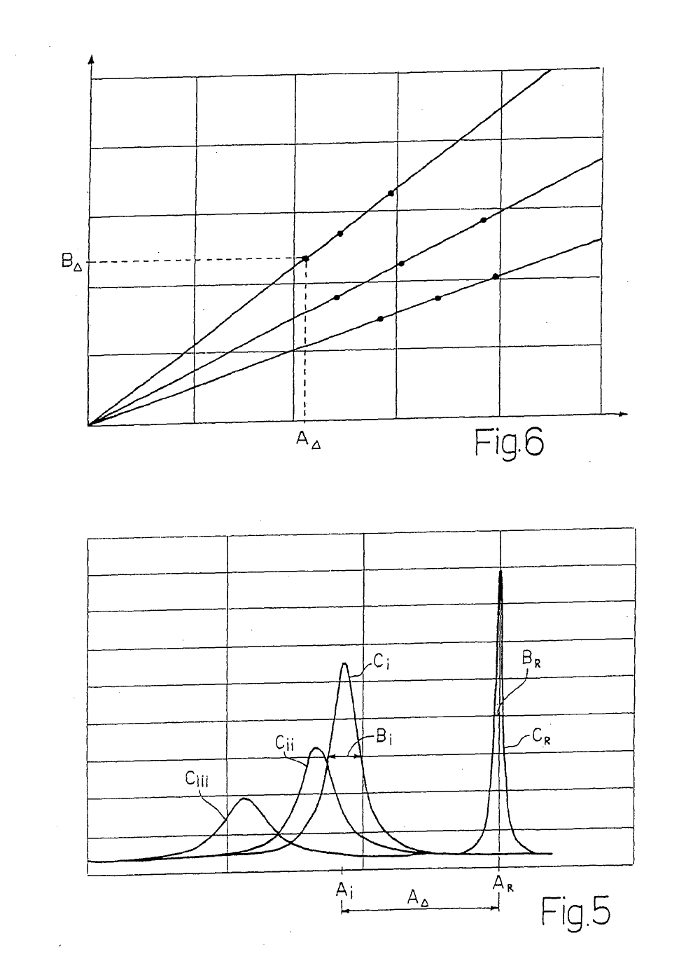

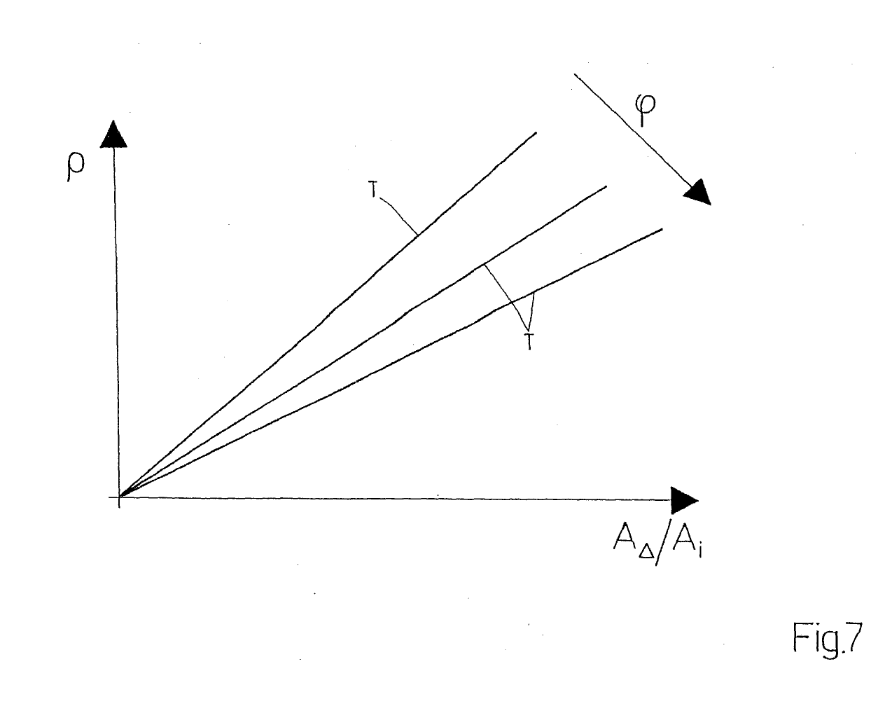

Operation of resonator 5 and processor 9 will now be explained more clearly with particular reference to FIGS. 5 and 6. Periodically, resonator 5 performs a sweep to vary the frequency of the microwaves in the microwave field between 1 GHz and 300 GHz. The frequency of the microwaves is preferably varied between 2 and 3 GHz to avoid heating the tobacco and/or any biological tissue in the microwave field.

FIG. 5—in which the x axis shows the microwave frequency, and the y axis the power measurement—shows a reference curve C_{R} of a reference signal obtained with substantially no object within the microwave field. Reference curve C_{R} peaks at a given reference frequency A_{R}, and has a reference amplitude B_{R} at mid-peak height.

FIG. 5 also shows response curves Cᵢ, Cᵢᵢ, Cᵢᵢᵢ of respective detection signals. Each response curve has a peak detected frequency Aᵢ, and a detected amplitude Bᵢ at mid-peak height, both of which depend on the humidity and density of a portion of cigarette rod 3.

In actual use, processor 9 receives the detection signal and determines the peak detected frequency Aᵢ and detected amplitude Bᵢ, which are then processed to compare the detection signal with the reference data item.

Processor 9 preferably determines a first deviation A_{Δ} between peak detected frequency Aᵢ and reference frequency A_{R}, and a second deviation B_{Δ} between detected amplitude Bᵢ and reference amplitude B_{R}. At which point, a detected humidity of cigarette rod 3 is calculated according to the equation:

$$ϕ = arc tg \frac{{A}_{Δ }}{{B}_{Δ}}$$

where φ is directly proportional to the detected humidity. In this connection, it should be pointed out that, in a test graph showing first deviation A_{Δ} along the x axis and second deviation BΔalong the y axis (as in FIG. 6), the points relative to detection signals of successive portions of cigarette rod 3 of substantially the same humidity lie substantially along the same lines.

Having calculated the detected humidity, processor 9 preferably determines a detected tobacco density as a function of the detected humidity and first deviation A_{Δ} or second deviation B_{Δ}. More specifically, the density is calculated using curves (in particular, lines) T (FIG. 7) determined experimentally beforehand, and each of which defines the density pattern (indicated ρ in FIG. 7) as a function of ratio A_{Δ}/Aᵢ at a constant given humidity (and therefore a constant given φ).

At this point, the detected density is compared with a reference density; and, when the difference between the detected density and the reference density exceeds the threshold value, an error signal is emitted.

Alternatively, resonator 5 and processor 9 may operate as described in one of the following documents DE202005010375, EP791823, EP902277.

In a further embodiment shown in FIG. 4, resonator 5 comprises two separate, substantially parallelepiped-shaped subunits 21 and 22; and each subunit 21, 22 comprises a respective body 10 having two respective half-shells 18, 19 of conducting material, and a respective chamber 11 bounded by the two half-shells 18, 19.

Each chamber 11 is in the form of a substantially asymmetrical T, and contains an element 23 of solid dielectric material (in particular, polyethylene or polyurethane).

In a further embodiment, not shown, each chamber 11 is L-shaped.

Each chamber 11 comprises portions 14 and 15, and body 10 comprises a wall 24 separating portion 14 and passage 13 and having an end surface 25, and an outer surface 26 crosswise to end surface 25 and at least partly defining passage 13; and a wall 27 located on the opposite side of portion 14 to wall 24, and having an inner surface 28. End surface 25 partly defines portion 15, and is of a width, measured substantially perpendicularly to direction A, greater than or equal to (preferably greater than) half the distance, measured parallel to said width at portion 15, between inner surface 28 and outer surface 26. More specifically, outer surface 26 is substantially parallel to inner surface 28 and substantially perpendicular to end surface 25; and the width and distance are measured radially with respect to a longitudinal axis of body 10 extending along lumen 12.

In this case, too, microwave field frequency can be varied by simply varying the length of portion 14.

In alternative embodiments not shown, chambers 11 only contain air.

In a further embodiment not shown, body 10 is formed in one piece, as opposed to comprising two half-shells.

In alternative embodiments not shown, body 10 defining chamber 11 comprises a first conducting material, such as steel; and a second conducting material, such as aluminium or Invar alloy. For example, body 10 may have half-shell 18 made of the first conducting material, and half-shell 19 made of the second conducting material, or may have portions of half-shell 18 made of the first conducting material, and portions of half-shell 19 made of the second conducting material.

Appropriately selecting the first and second conducting material and/or location of the half-shell portions made of the first or second conducting material minimizes thermal expansion of the metal material of body 10, and so prevents changes in the shape of chamber 11 defined by body 10.

Though the above description refers to use of device 4 for detecting and measuring tobacco density and/or humidity, it should be pointed out that the teachings of the present invention may also be used to advantage to determine at least one characteristic of other types of fibrous materials. For example, device 4 may be installed in a cigarette filter manufacturing machine and/or a cigar manufacturing machine.

By appropriately processing the detection signal, the teachings of the present invention may also be used to determine the presence and/or amount of foreign substances (e.g. plastic and/or metal particles) in the fibrous material.

1. A device for detecting at least one characteristic of a fibrous material, comprising a passage (13) along which the fibrous material is fed, in use, in a given first direction (A), and a microwave resonator (5); the resonator (5) comprising at least one body (10) made of at least a first conducting material, at least one chamber (11) bounded by said body (10), emitting means (6) for emitting microwave signals, and receiving means (8) for receiving microwave signals; the chamber (11) containing at least a first dielectric material; the resonator (5) at least partly defining said passage (13); said chamber (11) comprising a first portion (14) extending longitudinally substantially parallel to the given direction (A), and a second portion (15) extending from the first portion (14) and crosswise to the given direction (A); the second portion (15) having a first end (16) connected to the first portion (14), and an open second end (17) opposite the first end (16) and facing said passage (13); the device being characterized in that it comprises a separator (20) made of a second dielectric material; the separator (20) being housed inside the second portion (15), at the second end (17).

2. A device as claimed in claim 1, wherein the separator (20) is designed to substantially prevent fibrous material particles from entering the chamber (11).

3. A device as claimed in claim 1, wherein the second dielectric material has a different dielectric constant from the first dielectric material.

4. A device as claimed in claim 1, wherein the second portion (15) extends substantially perpendicularly to the given direction (A).

5. A device as claimed in claim 1, wherein the second portion (15) is bounded by said passage (13).

6. A device as claimed in claim 1, wherein the chamber (11) has an L-shaped section parallel to the given direction (A).

7. A device as claimed in claim 1, wherein the chamber (11) has a T-shaped section parallel to the given direction (A).

8. A device as claim 1, wherein the first dielectric material comprises air.

9. A device as claimed in claim 8, wherein the air in the chamber (11) is at a pressure of below 1 atm.

10. A device as claimed in claim 1, wherein the first dielectric material is substantially a vacuum.

11. A device as claimed in claim 1, wherein the first dielectric material is substantially polyethylene.

12. A device as claimed in claim 1, wherein the body (10) has a first part made of a first conducting material, and a second part made of a second conducting material.

13. A device as claimed in claim 1, wherein the resonator (5) is a coaxial resonator.

14. A device as claimed in claim 1, wherein the resonator (5) comprises a short-circuited transmission line and a capacitance.

15. A device as claimed in claim 1, wherein said body (10) comprises a first wall (24) separating the first portion (14) and said passage (13) and having an end surface (25), and an outer surface (26) crosswise to the end surface (25) and at least partly defining the passage (13); and a second wall (27) located on the opposite side of the first portion (14) to the first wall (24), and having an inner surface (28); the end surface (25) partly defining said second portion (15), and being of a width, measured substantially perpendicularly to the given direction (A), greater than or equal to half a distance between the inner surface (28) and said outer surface (26), which distance is measured parallel to said width, at the second portion (15).

16. A device as claimed in claim 15, wherein the outer surface (26) is substantially parallel to the inner surface (28) and substantially perpendicular to the end surface (25).

17. A device as claimed in claim 16, wherein the body (10) is of circular cylindrical annular shape, and defines a lumen (12) at least partly defining said passage (13); said width and said distance being measured radially with respect to a longitudinal axis of the body (10) extending along the lumen (12).

18. A device as claimed in claim 1, wherein the body (10) is of annular shape, and defines a lumen (12) at least partly defining said passage (13).

19. A device as claimed in claim 18, wherein the body (10) is of substantially circular cylindrical shape.

20. A device as claimed in claim 18, wherein the first and second portion (14, 15) of the chamber (11) are of respective annular shapes.

21. A device as claimed in claim 20, wherein the separator is annular in shape.

22. A device as claimed in claim 20, wherein the first and second portion (14, 15) and the separator (20) are of respective circular cylindrical shapes.

23. A device as claimed in claim 18, wherein the body (10) comprises two annular half-shells (18, 19) which, when combined, define said chamber.

24. A device as claimed in claim 1, wherein the resonator (5) comprises a first and a second subunit (21, 22) separate from each other; the first subunit (21) comprising a first body (10) of at least one conducting material, a first chamber (11) defined by said first body (10), and said emitting means (6); and the second subunit (22) comprising a second body (10) of at least one conducting material, a second chamber (11) defined by said second body (10), and said receiving means (8).

25. A device as claimed in claim 24, wherein the first and second body (10) are each substantially parallelepiped-shaped.

26. A device as claimed in claim 24, wherein the first and second chamber (11) are each T-shaped.

27. A device as claimed in claim 24, wherein the first and second chamber (11) are each L-shaped.

28. A device as claimed in claim 1, and for detecting the density and/or humidity of fibrous material, in particular tobacco.

29. A device for detecting at least one characteristic of a fibrous material, comprising a passage (13) along which the fibrous material is fed, in use, in a given first direction (A), and a microwave resonator (5); the resonator (5) comprising at least one body (10) of conducting material, at least one chamber (11) bounded by said body (10), emitting means (6) for emitting microwave signals, and receiving means (8) for receiving microwave signals; the chamber (11) containing at least one dielectric material; the resonator (5) at least partly defining said passage (13); and the device (4) being characterized in that the dielectric material is selected from the group comprising: air and a vacuum.

30. A device as claimed in claim 29, and as defined in claim 1 to 8.

31. A device as claimed in claim 1, wherein the emitting means (6) comprise an emitting antenna (6) oriented crosswise to the given direction (A).

32. A device as claimed in claim 1, wherein the receiving means (8) comprise a receiving antenna (8) oriented crosswise to the given direction (A).

33. A microwave resonator, as defined in claim 1.

34. A machine for producing cylindrical articles of the tobacco industry, comprising a device (4) as claimed in claim 1.
